(19) United States
(12) Patent Application Publication
(10) Pub. No.: US 2025/0199483 A1
(43) Pub. Date: Jun. 19, 2025

(54) SYSTEM, METHOD AND APPARATUS FOR REDUCING POWER CONTROL INTEGRAL WINDUP

(71) Applicant: Intel Corporation, Santa Clara, CA (US)

(72) Inventor: Ujjwal Gupta, Chandler, AZ (US)

(21) Appl. No.: 18/614,983

(22) Filed: Mar. 25, 2024

Related U.S. Application Data
(60) Provisional application No. 63/611,044, filed on Dec. 15, 2023.

(51) Int. Cl. G05B 11/42; G05B 13/04

(52) U.S. Cl. CPC G05B 11/42; G05B 13/042

(57) ABSTRACT

In an example, an apparatus includes: a proportional-integral-derivative (PID) controller to receive a first feedback signal and a second feedback signal, and determine, based at least in part on the first and second feedback signals, a first frequency; a circuit coupled to the PID controller to receive the determination of the first frequency and modify, based on at least one limit signal, the first frequency to a working point frequency and provide the working point frequency to at least one core to cause the at least one core to operate at the working point frequency; and a tracking error circuit coupled to the PID controller to receive the determination of the first frequency and an indication of the working point frequency and determine therefrom the second feedback signal, and provide the second feedback signal to the PID controller.

### CROSS-REFERENCE TO RELATED APPLICATION

This application claims the benefit of U.S. Provisional Application No. 63/611,044, filed on Dec. 15, 2023, and entitled “Automatic Integral Windup Correction For Running Average Power Limit Controllers In SOCS.”

### BACKGROUND

Modern processors can operate at high speed and with high power consumption, such that thermal concerns become an issue. Running average power limit (RAPL) control is often used for safe operation of computing systems having such processors. For example, a RAPL PL1 controller helps prevent a processor from consuming more than a thermal design power (TDP) limit within a time window of seconds. This mitigates the risk of a thermal runaway condition.

Some processors include one or more proportional-integral-derivative (PID) controllers for RAPL control. In a typical power management use case, an input to a PID controller indicates a difference between a power limit and an amount of power consumed by a processor or platform. The output of the PID controller is typically an operating frequency. Due to constraints on the maximum operating frequency, the PID controller can suffer from frequency discretization errors and/or integral wind-up (large “I” term in PID) problems, which tend to cause the PID controller to overshoot and/or converge to a power limit slowly. These overshoot and slow convergence problems can occur in several scenarios, such as running intensive workloads right after a long period of an idle condition or running multiple PID controller instances in parallel, when one PID controller can over-write the result of another PID controller.

### BRIEF DESCRIPTION OF THE DRAWINGS

FIG. 1 is a block diagram of a computing system in accordance with an embodiment.

FIG. 2 is a block diagram of a system on chip in accordance with an embodiment.

FIG. 3 is a block diagram of an apparatus in accordance with an embodiment.

FIG. 4 is a block diagram of an apparatus in accordance with another embodiment.

FIG. 5 is a flow diagram of a method in accordance with an embodiment.

FIGS. 6A-6C are graphical illustrations showing power control in accordance with an embodiment.

FIG. 7 illustrates an exemplary system.

FIG. 8 is a block diagram of an example processor in accordance with an embodiment.

FIG. 9A is a block diagram illustrating both an exemplary in-order pipeline and an exemplary register renaming, out-of-order issue/execution pipeline according to examples.

FIG. 9B is a block diagram illustrating both an exemplary example of an in-order architecture core and an exemplary register renaming, out-of-order issue/execution architecture core to be included in a processor according to examples.

FIG. 10 illustrates examples of execution unit(s) circuitry according to some examples.

FIG. 11 is a block diagram of a register architecture according to some examples.

### DETAILED DESCRIPTION

In various embodiments, a system on chip (SoC) is provided with one or more PID controllers that each receive multiple sources of feedback information and determine at least in part thereon, one or more control values for a controlled component such as a core or other intellectual property (IP) circuit, controller, fabric, memory, or so forth. Embodiments may be used in a wide variety of system contexts, including different types of computing systems, such as client and server systems. Embodiments may also be used to control different control variables, such as memory bandwidth (BW) in memory (e.g., dynamic random access memory (DRAM)-RAPL), and in connection with different arrangements of PID controllers (which are in a parallel configuration or a cascade configuration, for example). Other embodiments may be used to provide different outputs that may be controlled by linear relations of a single PID output (e.g., multiple IPs (e.g., a central processing unit (CPU), graphics processing unit (GPU), fabric).

In various embodiments, power control logic (e.g., comprising hardware, firmware and/or executing software) provides functionality for automatic correction of a “wind-up” condition where an integral term becomes excessively large. For example, the automatic correction comprises or is otherwise based on additional feedback to a PID controller, e.g., a PID controller which operates based on a RAPL to remove the excess increase in the integral term at runtime. In one such embodiment, the additional feedback is one of a total of two feedback loops in a PID controller. When one or more IPs are operating at their maximum frequency under control of such a PID controller, embodiments may ensure removal of any excess increase in the integral term. Since the integral term is more likely to remain in a constrained operating range, some embodiments mitigate the frequency and/or degree of overshoot events, and facilitate improved control responsiveness.

Some embodiments accommodate operation with any of various suitable PID controller implementation in a computing system (e.g., socket RAPL or DRAM RAPL). Some embodiments additionally or alternatively accommodate any of various numbers or types of core IPs and/or uncore IPs (such as fabric and GPU) or multiple socket systems. Some embodiments additionally or alternatively perform a relatively minimal tuning, e.g., as compared to previous solutions and/or facilitate the use of a wide range of turbo operations. Some embodiments additionally or alternatively enable users to change one or more PID power limits for any of various reasons that, for example, require very fast response times (e.g., on the order of approximately 25 milliseconds (ms)).

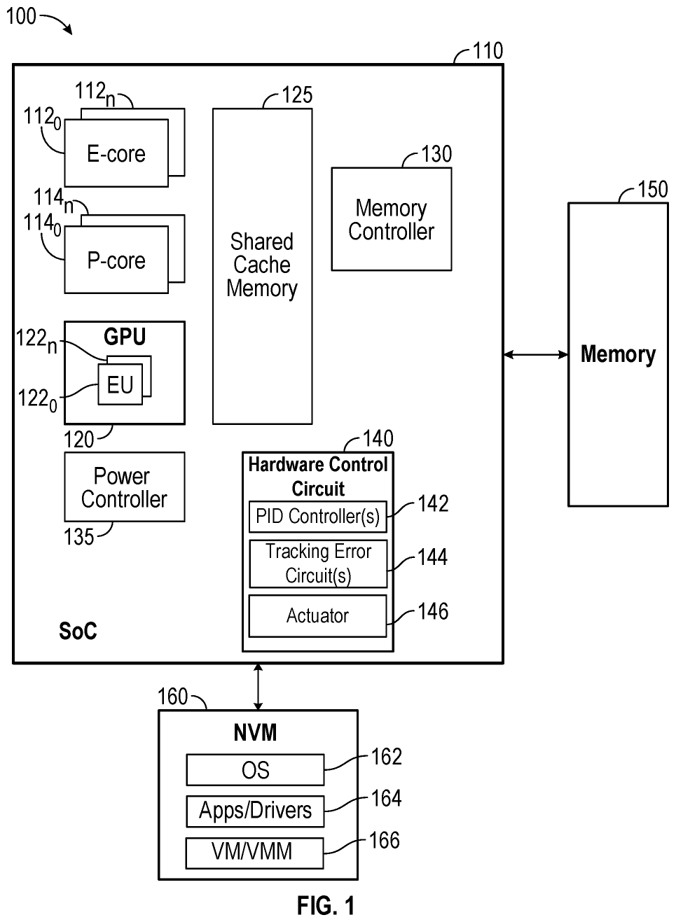

Referring now to FIG. 1, shown is a block diagram of a system in accordance with an embodiment. As shown in FIG. 1, computing system 100 may be any type of computing device, ranging from a relatively small device such as a smartphone to larger devices, including laptop computers, desktop computers, server computers or so forth. In the high level shown in FIG. 1, system 100 includes a processor that is implemented as an SoC 110, although other processor implementations are possible. As shown, processor SoC 110 couples to a memory 150 which is a system memory (e.g., a dynamic random access memory (DRAM)), and a non-volatile memory (NVM) 160 which in different embodiments can be implemented as a flash memory, disk drive or so forth. Understand that the terms “system on chip” or “SoC” are to be broadly construed to mean an integrated circuit having one or more semiconductor dies implemented in a package, whether a single die, a plurality of dies on a common substrate, or a plurality of dies at least some of which are in stacked relation. Thus as used herein, such SoCs are contemplated to include separate chiplets, dielets, and/or tiles, and the terms “system in package” and “SiP” are interchangeable with system on chip and SoC.

With respect to SoC 110, included are a plurality of cores. In the particular embodiment shown, two different core types are present, namely first cores 112₀-112ₙ (so-called efficiency cores (E-cores)) and second cores 114₀₋ₙ (so-called performance cores (P-cores)). As further shown, SoC 110 includes a graphics processing unit (GPU) 120 including a plurality of execution units (EUs) 122₀₋ₙ. In one or more embodiments, first cores 112 and second cores 114 and/or GPU 120 may be implemented on separate dies.

These various computing elements couple to additional components of SoC 110, including a shared cache memory 125, which in an embodiment may be a last level cache (LLC) having a distributed architecture. In addition, a memory controller 130 is present along with a power controller 135, which may be implemented as a hardware control circuit that may be a dedicated microcontroller to execute instructions, e.g., stored on a non-transitory storage medium (e.g., firmware instructions). In other cases, power controller 135 may have different portions that are distributed across one or more of the available cores.

Still with reference to FIG. 1, SoC 110 further includes a hardware control circuit 140 independent of power controller 135. In various embodiments herein, hardware control circuit 140 may include one or more PID controllers 142 in accordance with an embodiment. As such, PID controllers 142 are configured to receive multiple sources of feedback, including power consumption information (e.g., obtained from power controller 135) and tracking error information, which may be obtained from one or more tracking error circuits 144. In an embodiment, tracking error circuits 144 may be configured to monitor a difference between a control output of a given PID controller 142, and a resulting control output of an actuator 146. As will be described further herein, actuator 146 may operate to modify the control output of one or more PID controllers 142 based at least in part on one or more cap inputs and/or other constraints.

As further illustrated, NVM 160 may store an OS 162, various applications, drivers and other software (generally identified at 164), and one or more virtualization environments 166 (generally identified as VMM/VM 166).

Understand while shown at this high level in the embodiment of FIG. 1, many variations and alternatives are possible, and other implementations of SoC 100 can equally incorporate embodiments. For example depending on market segment, an SoC can include, instead of a hybrid product having heterogeneous core types, only cores of a single type. Further, more or different accelerator types may be present. For example, in addition to or instead of GPUs, an SoC may include a direct streaming accelerator (DSA), field programmable gate array (FPGA) or other accelerator.

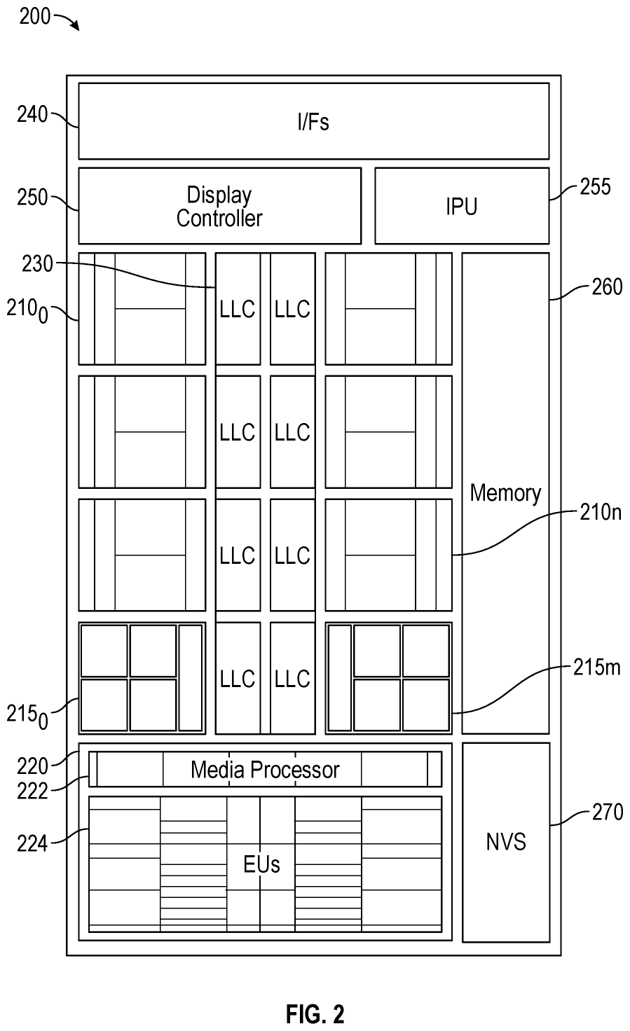

Referring now to FIG. 2, shown is a block diagram of an SoC in accordance with another embodiment. More specifically as shown in FIG. 2, SoC 200 is a multicore processor, including a first plurality of cores 210₀₋ₙ and a second plurality of cores 215₀₋ₘ. In one or more embodiments, first cores 210 may be implemented as performance cores, in that they may include greater amounts of circuitry (and wider and deeper pipelines) to perform more advanced computations in a performant manner. In contrast, second cores 215 may be configured as smaller cores that consume less power and may perform computations in a more efficient manner (e.g., with respect to power) than first cores 210. In certain implementations, first cores 210 may be referred to as P-cores (for performance cores) and second cores 215 may be referred to as E-cores (for efficiency cores). Note that different numbers of first and second cores may be present in different implementations.

As further illustrated in FIG. 2, a cache memory 230 may be implemented as a shared cache arranged in a distributed manner. In one or more embodiments, cache memory 230 may be a LLC having a distributed implementation in which one or more banks are associated with each of the cores.

As further illustrated, a GPU 220 may include a media processor 222 and a plurality of EUs 224. Graphics processor 220 may be configured for efficiently performing graphics or other operations that can be broken apart for execution on parallel processing units such as EUs 224.

Still referring to FIG. 2, various interface circuitry 240 is present to enable interface to other components of a system. Although embodiments are not limited in this regard, such interface circuitry may include a Peripheral Component Interconnect Express (PCIe) interface, one or more Thunderbolt™ interfaces, an Intel® Gaussian and Neural Accelerator (GNA) coprocessor and so forth. As further illustrated, processor 200 includes a display controller 250 and an image processing unit (IPU) 255.

As further shown, SoC 200 also includes a memory 260 that may provide memory controller functionality for interfacing with a system memory such as DRAM. Understand while shown at this high level in the embodiment of FIG. 2, many variations and alternatives are possible. Note that in this implementation, separate power controller circuitry such as power controller 135 and hardware control circuit 140 of FIG. 1 is not separately shown. Depending upon implementation, such components may be separate circuits present within SoC 200 or this functionality may be performed by one or more of first and/or second cores or other processing unit These circuits may implement PID control circuitry to operate based at least in part on multiple sources of feedback information, as described herein.

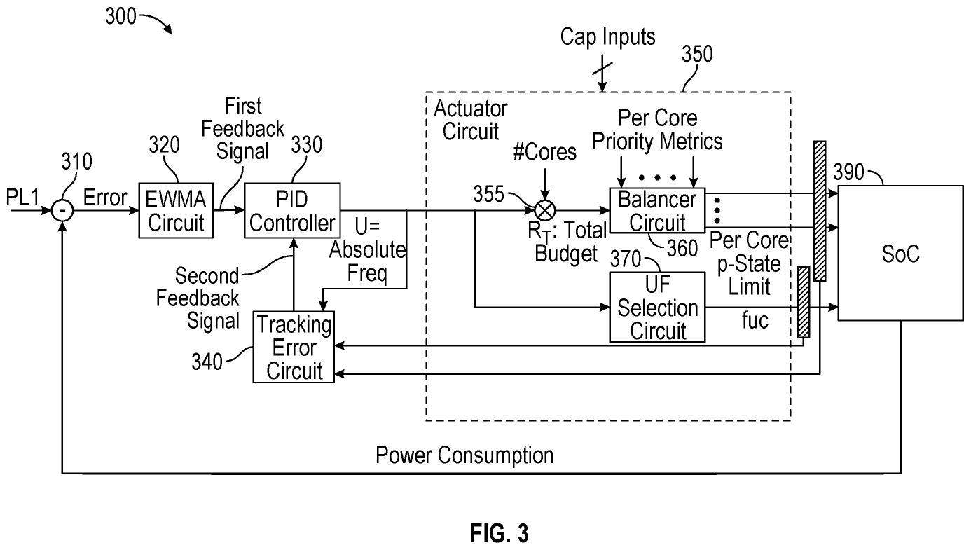

Referring now to FIG. 3, shown is a block diagram of a power controller in accordance with an embodiment. As shown in FIG. 3, controller 300 is provided with multiple feedback loops to enable a tracking error to be monitored and used in determining appropriate work points at which various IP circuits, and/or other circuitry of a processor socket and/or platform components can be operated. Understand that while in FIG. 3 controller 300 is shown at a relatively high level and in a hardware-based implementation, embodiments are not limited in this regard. That is, other implementations of a controller in accordance with an embodiment may take the form of a dedicated microcontroller, finite state machine, or other programmable circuitry to execute instructions such as may be stored in one or more non-transitory storage media, e.g., in the form of firmware and/or software.

In the embodiment of FIG. 3, first feedback information from a plant 390 is received in a first summer 310 (e.g., a comparator), which also receives a first set point. In the implementation shown in FIG. 1, this first set point may be a power limit, e.g., a PL1 power level. In an embodiment, the PL1 power level may correspond to a thermal design power (TDP) level, namely a long term power level for plant 390.

While plant 390 may take many different forms, assume for purposes of discussion that plant 390 is a SoC or other processor socket. As shown, plant 390 outputs the first feedback information, which may be a metric (IMON) of power consumption that is measured or otherwise detected at plant 390. First summer 310 thus is configured to calculate a difference between the value of the first set point and the value of the power consumption measurement, which it provides as an error signal, errorₖ, to an optional exponentially weighted moving average (EWMA) circuit 320.

When present, EWMA circuit 320 may operate to determine a weighted moving average value of this error signal and provide it to a PID controller 330. More specifically, EWMA circuit 320 is configured to calculate a running average of the error term errorₖ, e.g., using an exponential window moving average EWMA (errorₖ) such as the one illustrated by Equation (1) below, wherein IMON is the measured power consumption, and ΔT and τ tau are, respectively, the sampling interval of the power consumption and averaging time constant.

$$EWMA {:}_{{error}_{k} = {error}_{k - 1} +} ( 1 - e \{ \frac{- Δ T}{τ} \} ) ( PL 1 - {IMON}_{power} - {error}_{k - 1} ) \qquad [ Eq . 1 ]$$

However, in some embodiments, any of various other suitable types of average functions are used to calculate an average error value. In still other embodiments, an averaging of error values is omitted such that the first error signal is instead provided directly to PID controller 330 as first feedback information.

As further shown, PID controller 330 also receives second feedback information from a tracking error circuit 340. In turn, tracking error circuit 340 receives a set point determined in PID controller 330, namely a RAPL frequency (shown in FIG. 3 as an absolute frequency U, or fᵣₐₚₗ, also used herein), along with actual working point values provided to plant 390, which are output by an actuator 350. In embodiments, this absolute frequency may be a maximum frequency at which plant 390 is allowed to operate, based on the set point. As described further, in many cases, other constraints or cap values may cause this maximum frequency to be reduced to a lower frequency. Based on this information, tracking error circuit 340 is configured to determine a tracking error and provide this tracking error as the second feedback information to PID controller 330.

Based on these multiple sources of feedback information, PID controller 330 is configured to determine a PID set point, in the form of a RAPL frequency, which it provides to actuator circuit 350.

In an embodiment, PID 330 controller performs one or more calculations based on a proportional factor (Kp), an integral factor (Ki), and a derivative factor (Kd) terms. In one example embodiment, the term Kt does not require tuning, and (for example) can be set equal to the Ki term or, for example, within [0, Ki].

By way of illustration and not limitation, the PID controller calculates a proportional term proportionalₖ according to Equation (2) below.

$${proportional}_{k} = {K}_{p} {error}_{k} \qquad [ Eq . 2 ]$$

Furthermore, the PID controller calculates an integral term integralₖ according to Equation (3) below.

$${integral}_{k} = {integral}_{k - 1} + {K}_{i} {error}_{k} + {K}_{t} {e}_{t , k} \qquad [ Eq . 3 ]$$

In Equation (3) above, the tracking error term e_{t, k} is based on the feedback signal provided by tracking error circuit 340, e.g., where the term e_{t, k} is calculated according to Equation (4) below, where WP is the working point output by actuator circuit 350:

$${e}_{t , k} = {WP}_{k - 1} - {f}_{RAPL , k - 1} \qquad [ Eq . 4 ]$$

Further still, the PID controller calculates a derivative term derivativeₖ according to Equation (5) below.

$${derivative}_{k} = ( {error}_{k} - {error}_{k - 1} ) {K}_{d} \qquad [ Eq . 5 ]$$

In one such embodiment, the PID controller generates the output U according to Equation (6) below.

$${f}_{RAPL , k} = U = {proportional}_{k} + {integral}_{k} + {derivative}_{k} \qquad [ Eq . 6 ]$$

Although embodiments are not limited in this regard, the output U of PID controller 330 is an indication of a determination of an absolute frequency, e.g., a RAPL frequency that, for example, may be resolved with one or more other PID controllers and power management algorithms. The results are then applied to plant 390 as core and uncore frequency limits. More specifically, in the high level shown in FIG. 3, actuator circuit 350 includes various constituent components that can receive other sources of information and based on such information and the received absolute frequency, modify the absolute frequency to generate actual work points that are provided to plant 390 (and as feedback to tracking error circuit 340 as discussed above).

As shown in the high level of FIG. 3, actuator circuit 350 includes a multiplier 355 that receives the RAPL frequency and an indication of the number of cores or other IP circuits that are to use this value to generate a total budget, which it provides to a balancer circuit 360. Balancer circuit 360 is configured, based on this total budget and additional input information, such as per core priority metric information, along with additional input information, e.g., in the form of cap inputs, including control values from other PID controllers and/or other power management algorithms, to determine a per core work point. In an embodiment, the per core workpoint can be in the form of a per core P-state limit, namely, a given per core maximum operating frequency (and in some embodiments a maximum operating voltage).

In addition, a fabric selection circuit 370 also receives the RAPL frequency and based at least in part on this information, determines a frequency for non-core circuitry of plant 390, such as fabric or other interconnect and other non-core circuitry. In one embodiment, fabric selection circuit 370 is configured to determine this non-core operating frequency according to a linear function based on the RAPL frequency. To this end, in one implementation fabric selection circuit 370 may include a lookup table that stores various non-core frequency values, each of which is associated with a corresponding RAPL frequency.

Thus in FIG. 3, actuator circuit 350 operates to output various work points that it provides to plant 390, e.g., to one or more power controllers of plant 390, to cause various cores and other IP circuits to operate within the identified power limits. In addition, such work points also are provided as feedback to tracking error circuit 340, as described above.

In some embodiments, the computation of an IP workpoint feedback (WP) value, and calculation of a tracking error, changes depending on the type of power management employed in the system. By way of illustration and not limitation, in a monolithic system, some embodiments employ a non-hierarchical power management solution. Additionally or alternatively, for a multi-die system, some embodiments employ a hierarchical power management (HPM) implementation. For simplicity, certain features of various embodiments are described herein with reference to power control mechanism employed for monolithic systems.

In an illustrative scenario according to one embodiment, a tracking error has an initial value which is equal to zero at a time k=0—i.e., e_{t,0}=0. In one such embodiment, the actuator feedback and tracking error are determined with calculations, which (for example) are illustrated by Equations (7), (8), and (9) below. In this example, a fabric and a core are two illustrative IPs, although this example is easily generalizable to any of various suitable numbers of IPs.

$${f}_{uncore , adjusted , k} = \frac{( {Fabric}_{finalWP , k} - base )}{slope} \qquad [ Eq . 7 ]$$

$${WP}_{k} = \frac{( {\sum }_{i = 1}^{{n}_{c}} {CoreWP}_{finalWP , i , k} + {f}_{uncore , adjusted , k} )}{{n}_{c} + 1} \qquad [ Eq . 8 ]$$

$${e}_{t , k} = {WP}_{k - 1} - {f}_{RAPL , k - 1} ∀ k > 1 \qquad [ Eq . 9 ]$$

As a first step in this process, the operating frequency of an IP, such as the fabric (or cache coherent interconnect) called Fabric_{finalWP,k}, is back-calculated to the original PID output form. In Eq. 7, a reverse linear function is applied by subtracting the base and dividing by slope, which are static values. Then, all such adjusted frequencies for all IPs are collected and averaged. In Eq. 8, the final operating frequencies of all cores (or the best available estimate) are taken and the adjusted fabric frequency to obtain an average value of the system work-point (WP). This is fed back to each PID instance, the difference of the PID output (f_{RAPL,k-1}) and the system work-point (W Pₖ₋₁) is calculated to generate the tracking error (e_{t,k}), as shown in Eq. 9.

It is to be noted that, in Equation (8) there are a total of N_{act}=n_{c}+1 actuating signals, which (for example) comes from a total number of cores and fabric domains or total number of IPs.

Although shown at this high level in the embodiment of FIG. 3, many variations and alternatives are possible. For example, while embodiments herein are described in the context of a PID control mechanism, understand that in other implementations other types of control mechanisms, including a proportional-integral (PI) control mechanism (with Kt term (i.e., Kd=0) or other such control algorithms can be used.

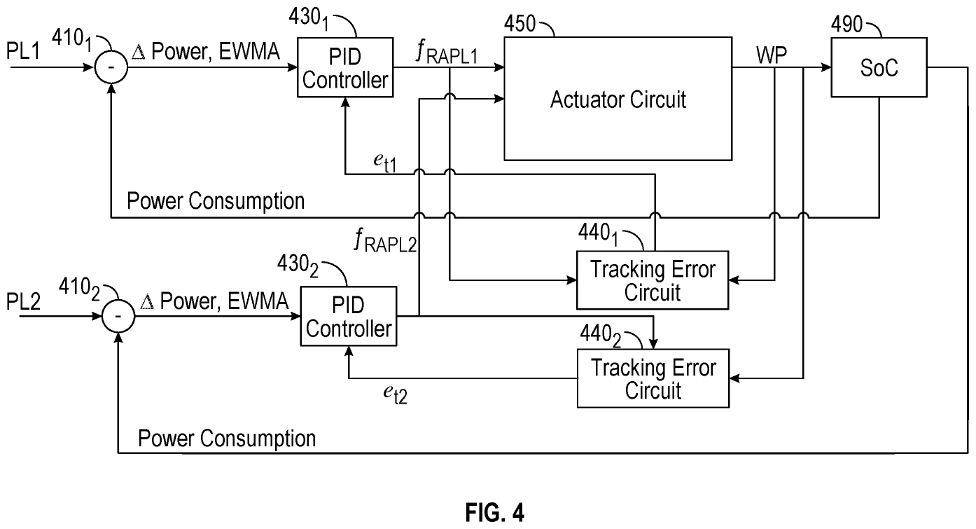

Referring now to FIG. 4, shown is a block diagram of a power controller in accordance with another embodiment. In the embodiment of FIG. 4, controller 400 includes multiple PID controllers that both receive multiple sources of feedback, thus providing tracking error feedback functionality for multiple PID controllers. In general, controller 400 is implemented similarly to controller 300 of FIG. 3 (with the same reference numerals, albeit of the “400” series), and thus similar components are not discussed in detail.)

In the example embodiment shown, two PID controllers 4301, 2 are used to a control PL1 limit and a PL2 limit, which may be a peak power limit. The two PIDs each correspond to (and are coupled to receive) a different respective error correction term (e.g., the illustrative tracking error terms eₜ₁ and eₜ₂ shown). However, different embodiments scale to any of various other numbers of PID controllers. Also, understand that the implementation shown in FIG. 4 is at a high level and simplified for purposes of illustration. For example, EWMA circuits are not shown. Nor are limit inputs into actuator circuit 450; understand of course that these components may be present in a particular embodiment.

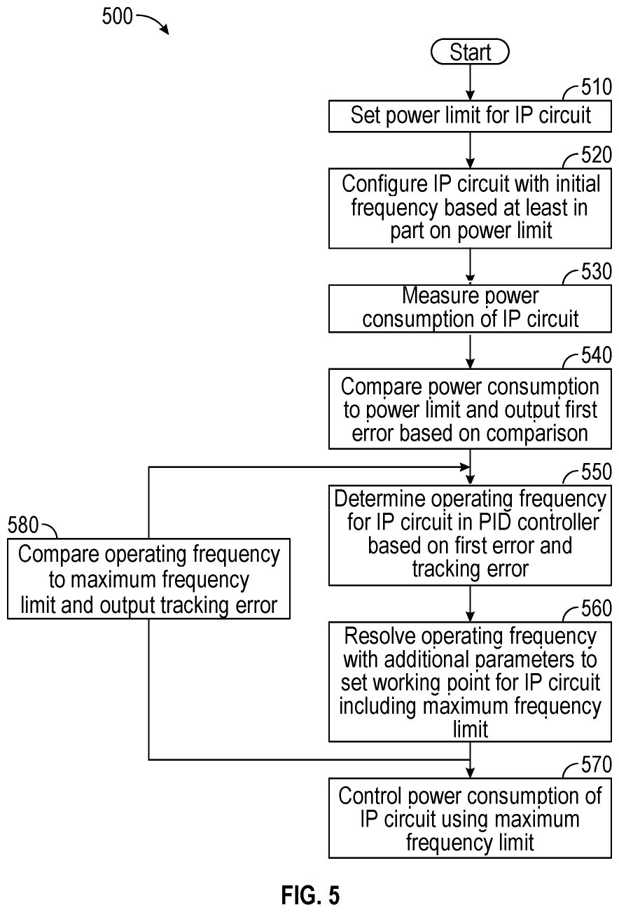

Referring now to FIG. 5, shown is a flow diagram of a method in accordance with an embodiment. As shown in FIG. 5, method 500 may be performed by a controller, such as a power controller of an SoC that includes or is coupled to multiple PID controllers. As such, method 500 may be performed by hardware circuitry alone and/or combination with firmware and/or software. For example, method 500 in one implementation may be performed at least in part using power control firmware, such as may be implemented as so-called P-code.

As shown, method 500 begins by setting a power limit for an IP circuit (block 510). For purposes of discussion, assume that this power limit is a PL1 limit that is set for at least one core. Next at block 520 this IP circuit, e.g., core, is configured with an initial frequency that is based at least in part on the power limit. For example, in the absence of any constraints, the initial frequency at which this IP circuit may operate can be set to a maximum level consistent with the power limit and/or overall socket power budget.

Still referring to FIG. 5, during normal operation power consumption of the IP circuit may be measured (block 530). This power consumption information may be provided to a comparator, which compares the measured power consumption to the power limit and outputs a first error based on the comparison (block 540). Next at block 550, in a PID controller an operating frequency for the IP circuit can be determined. More specifically, this operating frequency, which may be an absolute or RAPL frequency, can be determined based on the first error and a tracking error, received from a tracking error circuit as described herein.

Next at block 560, the operating frequency can be resolved with additional parameters, such as one or more cap values that may be received from other PID controllers, power management algorithms, or so forth. Based on this resolution, a working point can be set for the IP circuit that includes a maximum frequency limit (block 560). Note that this maximum frequency limit may be provided to the IP circuit as a working point frequency.

Still referring to FIG. 5, this operating frequency also may be provided to a tracking error circuit, which may compare the maximum frequency limit to the absolute operating frequency, e.g., RAPL frequency (block 580). Based at least in part on this comparison, the tracking error circuit outputs the tracking error, which is provided to the PID controller.

Still with reference to FIG. 5, at block 570 power consumption of the IP circuit may be controlled using the maximum frequency limit. In some cases, this power control may simply be implemented by providing an operating frequency to the IP circuit at this maximum frequency limit. In other cases, when the IP circuit is configured to manage its own frequency, the IP circuit may operate at frequencies lower than or up to this maximum frequency limit. Understand while shown at this high level and the embodiment of FIG. 5, many variations and alternatives are possible.

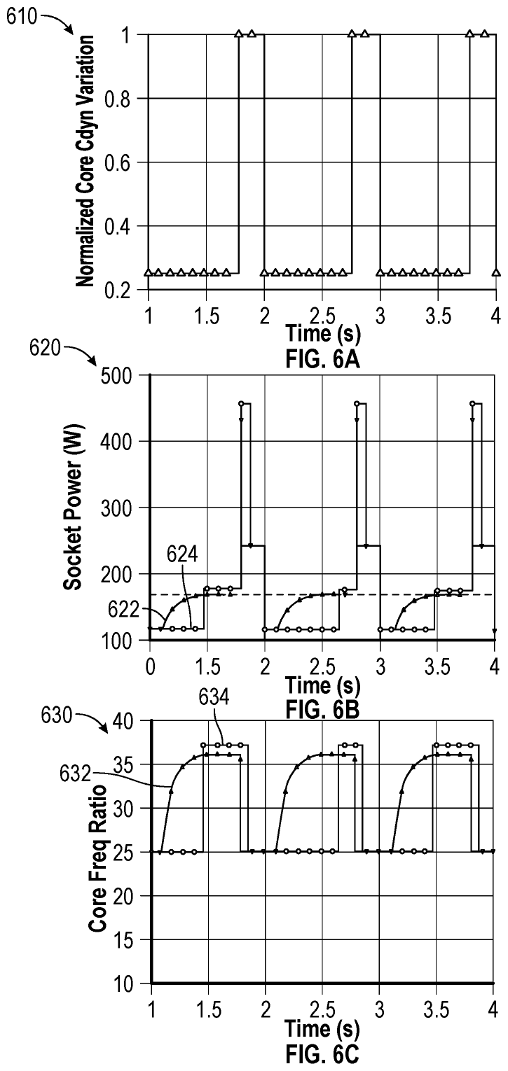

Referring now to FIGS. 6A-6C, shown are graphical illustrations comparing operation in accordance with an embodiment to conventional PID control operation. As seen first in FIG. 6A, illustration 610 shows a normalized dynamic capacitance, Cdyn, for a workload having two phases, namely a low activity phase followed by a high activity phase. In FIG. 6B, illustration 620 shows socket power consumption for this workload for both a conventional PID control mechanism (at curve 624) and a simulation of a PID control mechanism in accordance with an embodiment (at curve 622). As shown, power consumption may increase more rapidly with an embodiment, providing greater performance while staying below a power limit (e.g., the TDP level shown in the dashed line), other than an instantaneous pulse. And in FIG. 6C, illustration 630 shows that core frequency may increase faster using an embodiment (comparing curve 632 to curve 634), providing greater performance.

Detailed below are describes of exemplary computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

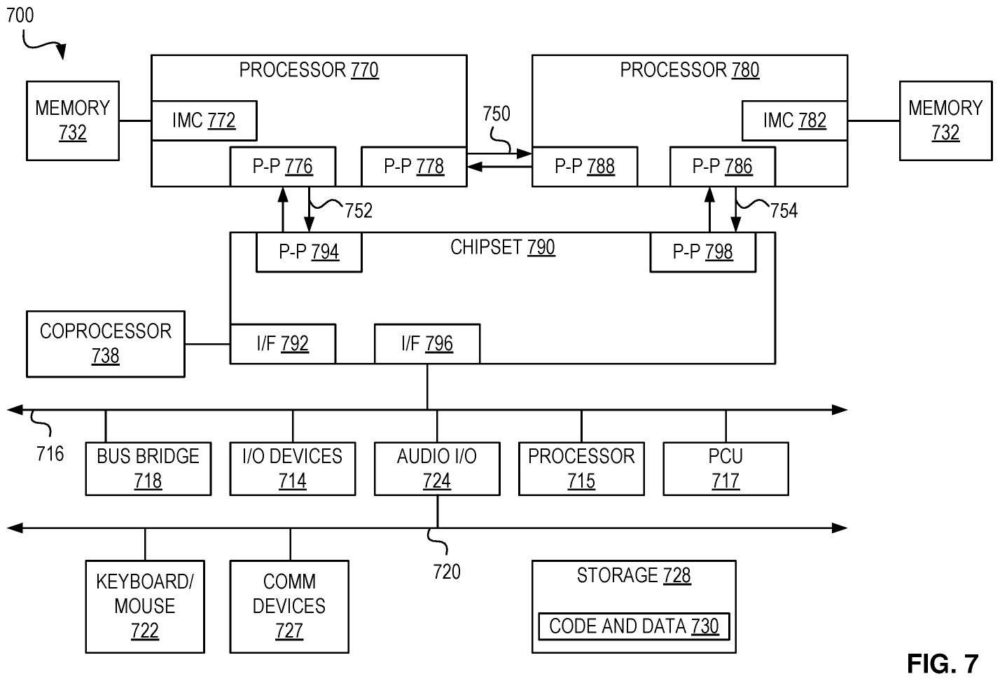

FIG. 7 illustrates an exemplary system. Multiprocessor system 700 is a point-to-point interconnect system and includes a plurality of processors including a first processor 770 and a second processor 780 coupled via a point-to-point interconnect 750. In some examples, the first processor 770 and the second processor 780 are homogeneous. In some examples, first processor 770 and the second processor 780 are heterogenous. Though the exemplary system 700 is shown to have two processors, the system may have three or more processors, or may be a single processor system.

Processors 770 and 780 are shown including integrated memory controller (IMC) circuitry 772 and 782, respectively. Processor 770 also includes as part of its interconnect controller point-to-point (P-P) interfaces 776 and 778; similarly, second processor 780 includes P-P interfaces 786 and 788. Processors 770, 780 may exchange information via the point-to-point (P-P) interconnect 750 using P-P interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a chipset 790 via individual P-P interconnects 752, 754 using point to point interface circuits 776, 794, 786, 798. Chipset 790 may optionally exchange information with a coprocessor 738 via an interface 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via P-P interconnect, such that either or both processors' local cache information may be stored in the shared cache if a processor is placed into a low power mode.

Chipset 790 may be coupled to a first interconnect 716 via an interface 796. In some examples, first interconnect 716 may be a Peripheral Component Interconnect (PCI) interconnect, or an interconnect such as a PCI Express interconnect or another I/O interconnect. In some examples, one of the interconnects couples to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software). In one or more embodiments, PCU 717 may include PID control circuitry to operate based at least in part on multiple sources of feedback information, as described herein.

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interconnect 716, along with a bus bridge 718 which couples first interconnect 716 to a second interconnect 720. In some examples, one or more additional processor(s) 715, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 716. In some examples, second interconnect 720 may be a low pin count (LPC) interconnect. Various devices may be coupled to second interconnect 720 including, for example, a keyboard and/or mouse 722, communication devices 727 and a storage circuitry 728. Storage circuitry 728 may be one or more non-transitory machine-readable storage media as described below, such as a disk drive or other mass storage device which may include instructions/code and data 730 in some examples. Further, an audio I/O 724 may be coupled to second interconnect 720. Note that other architectures than the point-to-point architecture described above are possible. For example, instead of the point-to-point architecture, a system such as multiprocessor system 700 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

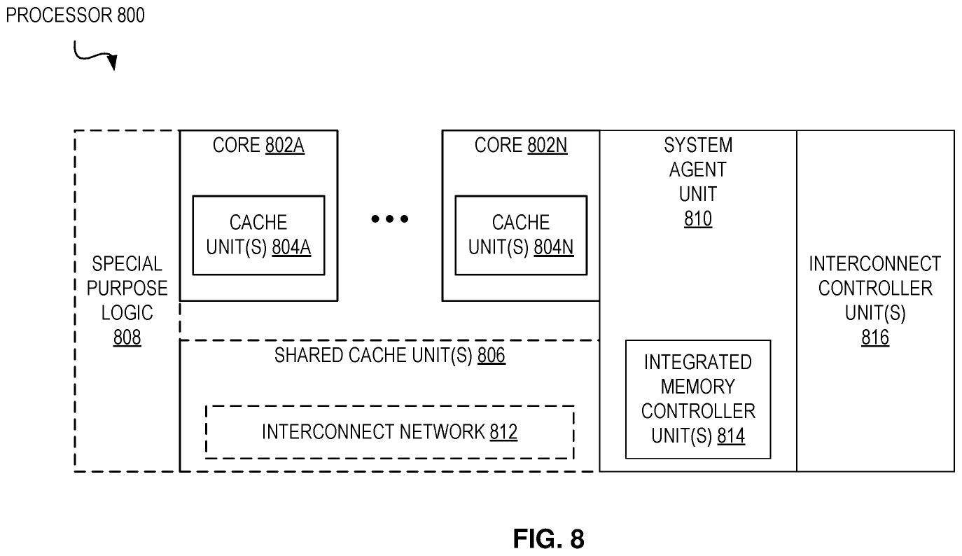

FIG. 8 illustrates a block diagram of an example processor 800 that may have more than one core and an integrated memory controller. The solid lined boxes illustrate a processor 800 with a single core 802A, a system agent unit circuitry 810, a set of one or more interconnect controller unit(s) circuitry 816, while the optional addition of the dashed lined boxes illustrates an alternative processor 800 with multiple cores 802A-N, a set of one or more integrated memory controller unit(s) circuitry 814 in the system agent unit circuitry 810, and special purpose logic 808, as well as a set of one or more interconnect controller units circuitry 816. Note that the processor 800 may be one of the processors 770 or 780, or co-processor 738 of FIG. 7.

Thus, different implementations of the processor 800 may include: 1) a CPU with the special purpose logic 808 being integrated graphics and/or scientific (throughput) logic (which may include one or more cores, not shown), and the cores 802A-N being one or more general purpose cores (e.g., general purpose in-order cores, general purpose out-of-order cores, or a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804A-N within the cores 802A-N, a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples ring-based interconnect network circuitry 812 interconnects the special purpose logic 808 (e.g., integrated graphics logic), the set of shared cache unit(s) circuitry 806, and the system agent unit circuitry 810, alternative examples use any number of well-known techniques for interconnecting such units. In some examples, coherency is maintained between one or more of the shared cache unit(s) circuitry 806 and cores 802A-N.

In some examples, one or more of the cores 802A-N are capable of multi-threading. The system agent unit circuitry 810 includes those components coordinating and operating cores 802A-N. The system agent unit circuitry 810 may include, for example, power control unit (PCU) circuitry and/or display unit circuitry (not shown). The PCU may be or may include logic and components needed for regulating the power state of the cores 802A-N and/or the special purpose logic 808 (e.g., integrated graphics logic), and may include PID control circuitry as described herein. The display unit circuitry is for driving one or more externally connected displays.

The cores 802A-N may be homogenous in terms of instruction set architecture (ISA). Alternatively, the cores 802A-N may be heterogeneous in terms of ISA; that is, a subset of the cores 802A-N may be capable of executing an ISA, while other cores may be capable of executing only a subset of that ISA or another ISA.

### Exemplary Core Architectures-In-Order and Out-of-Order Core Block Diagram.

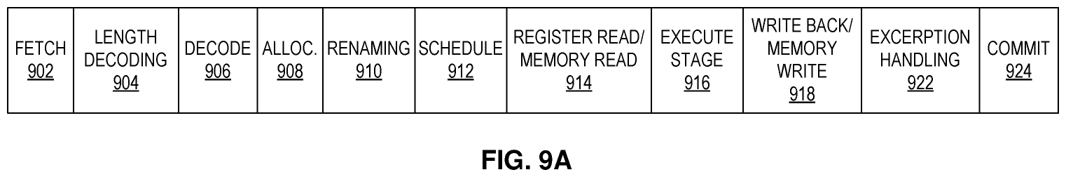

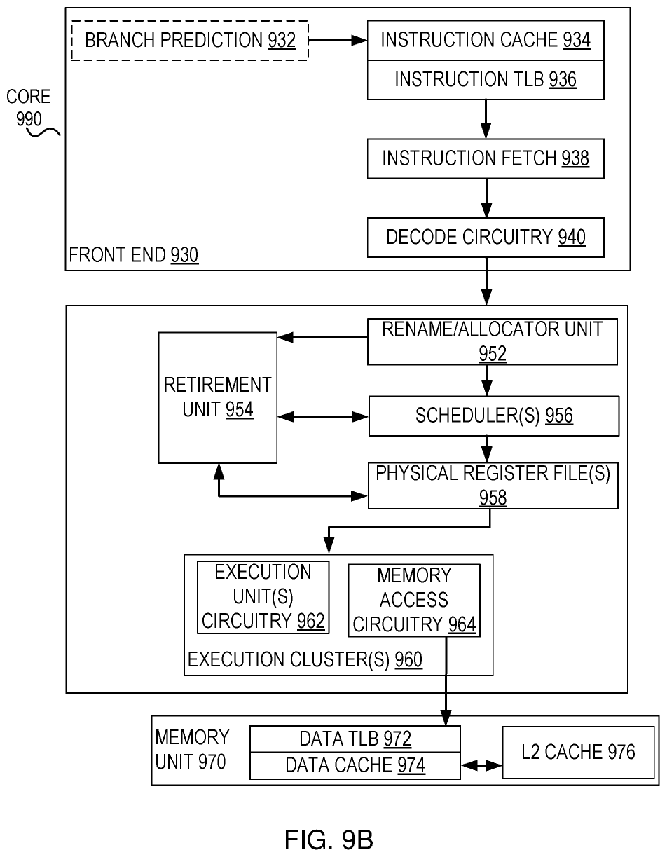

FIG. 9A is a block diagram illustrating both an exemplary in-order pipeline and an exemplary register renaming, out-of-order issue/execution pipeline according to examples. FIG. 9B is a block diagram illustrating both an exemplary example of an in-order architecture core and an exemplary register renaming, out-of-order issue/execution architecture core to be included in a processor according to examples. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 906 and the register read/memory read stage 914 may be combined into one pipeline stage. In one example, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 9B may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9B shows a processor core 990 including front-end unit circuitry 930 coupled to an execution engine unit circuitry 950, and both are coupled to a memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit circuitry 930 may include branch prediction circuitry 932 coupled to an instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to a retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, arithmetic generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to a data cache circuitry 974 coupled to a level 2 (L2) cache circuitry 976. In one exemplary example, the memory access circuitry 964 may include a load unit circuitry, a store address unit circuit, and a store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, a level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 990 includes logic to support a packed data instruction set architecture extension (e.g., AVX1, AVX2), thereby allowing the operations used by many multimedia applications to be performed using packed data.

### Exemplary Execution Unit(s) Circuitry

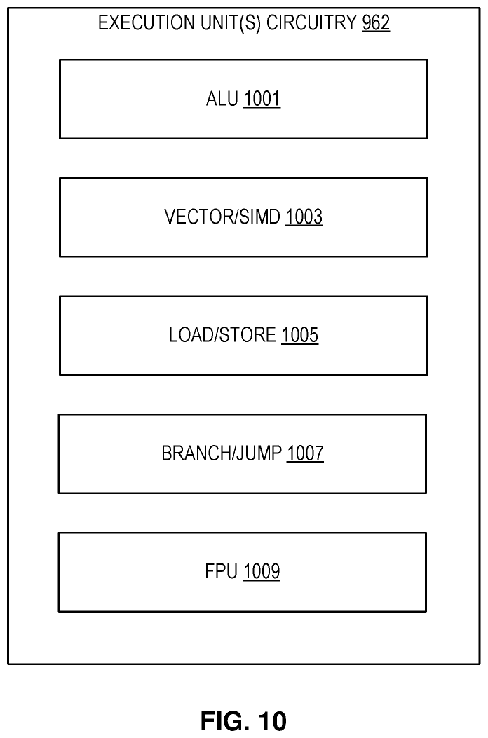

FIG. 10 illustrates examples of execution unit(s) circuitry, such as execution unit(s) circuitry 962 of FIG. 9B. As illustrated, execution unit(s) circuitry 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

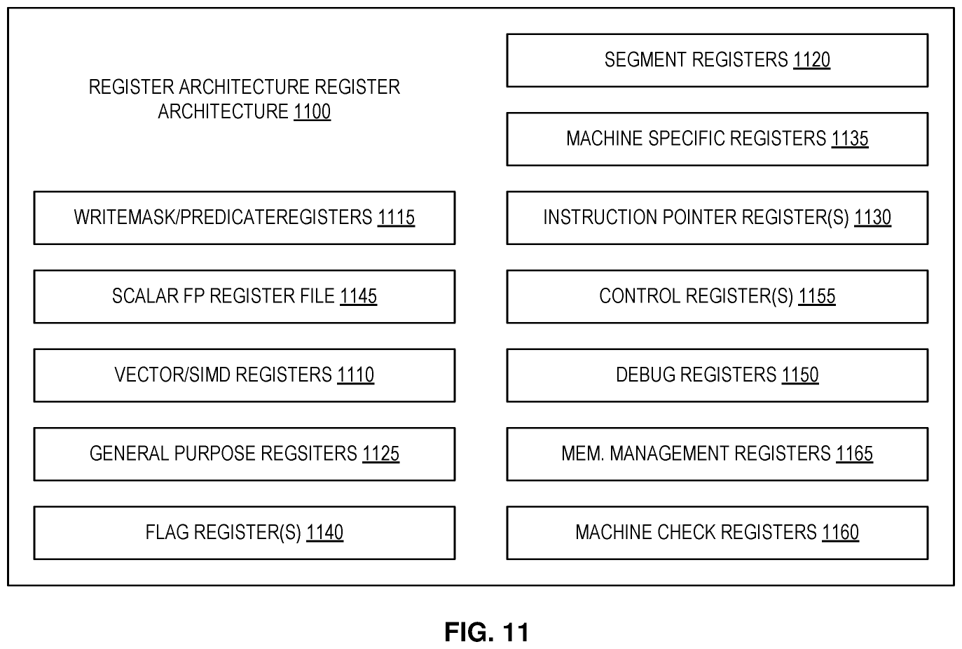

FIG. 11 is a block diagram of a register architecture 1100 according to some examples. As illustrated, the register architecture 1100 includes vector/SIMD registers 1110 that vary from 128-bit to 1,024 bits width. In some examples, the vector/SIMD registers 1110 are physically 512-bits and, depending upon the mapping, only some of the lower bits are used. For example, in some examples, the vector/SIMD registers 1110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1100 includes writemask/predicate registers 1115. For example, in some examples, there are 8 writemask/predicate registers (sometimes called k0 through k7) that are each 16-bit, 32-bit, 64-bit, or 128-bit in size. Writemask/predicate registers 1115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1115 corresponds to a data element position of the destination. In other examples, the writemask/predicate registers 1115 are scalable and consists of a set number of enable bits for a given vector element (e.g., 8 enable bits per 64-bit vector element).

The register architecture 1100 includes a plurality of general-purpose registers 1125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1100 includes scalar floating-point (FP) register 1145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1140 (e.g., EFLAGS, RFLAGS, etc.) store status and control information for arithmetic, compare, and system operations. For example, the one or more flag registers 1140 may store condition code information such as carry, parity, auxiliary carry, zero, sign, and overflow. In some examples, the one or more flag registers 1140 are called program status and control registers.

Segment registers 112₀ contain segment points for use in accessing memory. In some examples, these registers are referenced by the names CS, DS, SS, ES, FS, and GS.

Machine specific registers (MSRs) 1135 control and report on processor performance. Most MSRs 1135 handle system-related functions and are not accessible to an application program. Machine check registers 1160 consist of control, status, and error reporting MSRs that are used to detect and report on hardware errors.

One or more instruction pointer register(s) 1130 store an instruction pointer value. Control register(s) 1155 (e.g., CR0-CR4) determine the operating mode of a processor (e.g., processor 770, 780, 738, 715, and/or 800) and the characteristics of a currently executing task. Debug registers 1150 control and allow for the monitoring of a processor or core's debugging operations.

The following examples pertain to further embodiments.

In one example, an apparatus includes: a PID controller to receive a first feedback signal and a second feedback signal, and determine, based at least in part on the first feedback signal and the second feedback signal, a first frequency; a circuit coupled to the PID controller, the circuit to receive the determination of the first frequency and modify, based on at least one limit signal, the first frequency to a working point frequency and provide the working point frequency to at least one core to cause the at least one core to operate at the working point frequency; and a tracking error circuit coupled to the PID controller, the tracking error circuit to receive the determination of the first frequency and an indication of the working point frequency and determine therefrom the second feedback signal, and provide the second feedback signal to the PID controller.

In an example, the PID controller is to receive the first feedback signal comprising a first error signal, the first error signal based on a power consumption of the at least one core and a first power limit.

In an example, the apparatus further comprises a moving average circuit coupled to the PID controller, the moving average circuit to receive the first error signal and generate the first feedback signal comprising a moving average of the first error signal.

In an example, the tracking error circuit is to determine the second feedback signal based on a difference between the first frequency and the working point frequency.

In an example, the PID controller is to calculate an integral term based at least in part on the first feedback signal and the second feedback signal.

In an example, the PID controller is to calculate the integral term according to:

$${integral}_{k} = {integral}_{k - 1} + {K}_{i} {error}_{k} + {K}_{t} {e}_{t , k} ,$$

where integralₖ₋₁, is a prior integral term, Kᵢ is a first constant, errorₖ is the first feedback signal, Kₜ is a second constant, and e_{t,k} is the tracking error signal.

In an example, the circuit is to modify the first frequency to the working point frequency, the working point frequency less than the first frequency, based on the at least one limit signal comprising a core priority metric.

In an example, the circuit further is to determine a fabric frequency based at least in part on the first frequency.

In an example, the apparatus further comprises a second PID controller to receive a third feedback signal and a fourth feedback signal, and determine, based at least in part on the third feedback signal and the fourth feedback signal, a second frequency, the second PID controller to provide the determination of the second frequency to the circuit, the circuit to modify, based on the at least one limit signal and the determination of the second frequency, the first frequency to the working point frequency.

In an example, the apparatus further comprises a second tracking error circuit coupled to the second PID controller, the second tracking error circuit to receive the determination of the second frequency and the indication of the working point frequency and determine therefrom the fourth feedback signal, and provide the fourth feedback signal to the second PID controller.

In another example, a method comprises: receiving a first feedback signal based at least in part on a working point frequency of a core of a processor and a second feedback signal; determining, based at least in part on the first feedback signal and the second feedback signal, a first frequency; modifying, based on at least one limit signal, the first frequency to the working point frequency and providing the working point frequency to the core to cause the core to operate at the working point frequency; and determining, based on the first frequency and the working point frequency, the second feedback signal.

In an example, receiving the first feedback signal comprises receiving a first error signal, the first error signal based on a power consumption of the core and a first power limit.

In an example, the method further comprises generating the first feedback signal comprising a moving average of the first error signal.

In an example, the method further comprises determining the second feedback signal based on a difference between the first frequency and the working point frequency.

In an example, the method further comprises calculating an integral term based at least in part on the first feedback signal and the second feedback signal.

In an example, the method further comprises calculating the integral term according to:

$${integral}_{k} = {integral}_{k - 1} + {K}_{i} {error}_{k} + {K}_{t} {e}_{t , k} ,$$

where integralₖ₋₁, is a prior integral term, Kᵢ is a first constant, errorₖ is the first feedback signal, Kₜ is a second constant, and e_{t,k} is the tracking error signal.

In an example, the method further comprises modifying the first frequency to the working point frequency, the working point frequency less than the first frequency, based on the at least one limit signal comprising a core priority metric.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system on chip includes: at least one core to execute instructions; and a power controller coupled to the at least one core. The power controller may include: a first PID controller to receive a first feedback signal based at least in part on a first power limit and a second feedback signal, and determine, based at least in part on the first feedback signal and the second feedback signal, a first frequency at which the at least one core is to operate; a second PID controller to receive a third feedback signal based at least in part on a second power limit and a fourth feedback signal, and determine, based at least in part on the third feedback signal and the fourth feedback signal, a second frequency at which the at least one core is to operate; and a circuit coupled to the first PID controller and the second PID controller, the circuit to receive the determination of the first frequency and the determination of the second frequency and determine based at least in part thereon, a working point frequency for the at least one core and provide the working point frequency to the at least one core to cause the at least one core to operate at the working point frequency.

In an example, the power controller further comprises: a first tracking error circuit coupled to the first PID controller, the first tracking error circuit to receive the determination of the first frequency and an indication of the working point frequency and determine therefrom the second feedback signal; and a second tracking error circuit coupled to the second PID controller, the second tracking error circuit to receive the determination of the second frequency and the indication of the working point frequency and determine therefrom the fourth feedback signal.

In an example, the circuit is to receive at least one cap value and determine the working point frequency for the at least one core further based on the at least one cap value.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
a proportional-integral-derivative (PID) controller to receive a first feedback signal and a second feedback signal, and determine, based at least in part on the first feedback signal and the second feedback signal, a first frequency;
a circuit coupled to the PID controller, the circuit to receive the determination of the first frequency and modify, based on at least one limit signal, the first frequency to a working point frequency and provide the working point frequency to at least one core to cause the at least one core to operate at the working point frequency; and
a tracking error circuit coupled to the PID controller, the tracking error circuit to receive the determination of the first frequency and an indication of the working point frequency and determine therefrom the second feedback signal, and provide the second feedback signal to the PID controller.

2. The apparatus of claim 1, wherein the PID controller is to receive the first feedback signal comprising a first error signal, the first error signal based on a power consumption of the at least one core and a first power limit.

3. The apparatus of claim 2, further comprising a moving average circuit coupled to the PID controller, wherein the moving average circuit is to receive the first error signal and generate the first feedback signal comprising a moving average of the first error signal.

4. The apparatus of claim 1, wherein the tracking error circuit is to determine the second feedback signal based on a difference between the first frequency and the working point frequency.

5. The apparatus of claim 1, wherein the PID controller is to calculate an integral term based at least in part on the first feedback signal and the second feedback signal.

6. The apparatus of claim 5, wherein the PID controller is to calculate the integral term according to:
$${integral}_{k} = {integral}_{k - 1} + {K}_{i} {error}_{k} + {K}_{t} {e}_{t , k} ,$$
wherein integralₖ₋₁, is a prior integral term, Kᵢ is a first constant, errorₖ is the first feedback signal, Kₜ is a second constant, and e_{t,k} is the tracking error signal.

7. The apparatus of claim 1, wherein the circuit is to modify the first frequency to the working point frequency, the working point frequency less than the first frequency, based on the at least one limit signal comprising a core priority metric.

8. The apparatus of claim 1, wherein the circuit further is to determine a fabric frequency based at least in part on the first frequency.

9. The apparatus of claim 1, further comprising a second PID controller to receive a third feedback signal and a fourth feedback signal, and determine, based at least in part on the third feedback signal and the fourth feedback signal, a second frequency, the second PID controller to provide the determination of the second frequency to the circuit, the circuit to modify, based on the at least one limit signal and the determination of the second frequency, the first frequency to the working point frequency.

10. The apparatus of claim 9, further comprising a second tracking error circuit coupled to the second PID controller, the second tracking error circuit to receive the determination of the second frequency and the indication of the working point frequency and determine therefrom the fourth feedback signal, and provide the fourth feedback signal to the second PID controller.

11. At least one computer readable medium comprising instructions, which when executed by a processor, cause the processor to execute a method comprising:
receiving a first feedback signal based at least in part on a working point frequency of a core of a processor and a second feedback signal;
determining, based at least in part on the first feedback signal and the second feedback signal, a first frequency;
modifying, based on at least one limit signal, the first frequency to the working point frequency and providing the working point frequency to the core to cause the core to operate at the working point frequency; and
determining, based on the first frequency and the working point frequency, the second feedback signal.

12. The at least one computer readable medium of claim 11, wherein receiving the first feedback signal comprises receiving a first error signal, the first error signal based on a power consumption of the core and a first power limit.

13. The at least one computer readable medium of claim 11, wherein the method further comprises generating the first feedback signal comprising a moving average of the first error signal.

14. The at least one computer readable medium of claim 13, wherein the method further comprises determining the second feedback signal based on a difference between the first frequency and the working point frequency.

15. The at least one computer readable medium of claim 11, wherein the method further comprises calculating an integral term based at least in part on the first feedback signal and the second feedback signal.

16. The at least one computer readable medium of claim 15, wherein the method further comprises calculating the integral term according to:
$${integral}_{k} = {integral}_{k - 1} + {K}_{i} {error}_{k} + {K}_{t} {e}_{t , k} ,$$
wherein integralₖ₋₁, is a prior integral term, Kᵢ is a first constant, errorₖ is the first feedback signal, Kₜ is a second constant, and e_{t,k} is the tracking error signal.

17. The at least one computer readable medium of claim 11, wherein the method further comprises modifying the first frequency to the working point frequency, the working point frequency less than the first frequency, based on the at least one limit signal comprising a core priority metric.

18. A system on chip comprising:
at least one core to execute instructions; and
a power controller coupled to the at least one core, wherein the power controller comprises:
a first proportional-integral-derivative (PID) controller to receive a first feedback signal based at least in part on a first power limit and a second feedback signal, and determine, based at least in part on the first feedback signal and the second feedback signal, a first frequency at which the at least one core is to operate;
a second PID controller to receive a third feedback signal based at least in part on a second power limit and a fourth feedback signal, and determine, based at least in part on the third feedback signal and the fourth feedback signal, a second frequency at which the at least one core is to operate; and
a circuit coupled to the first PID controller and the second PID controller, the circuit to receive the determination of the first frequency and the determination of the second frequency and determine based at least in part thereon, a working point frequency for the at least one core and provide the working point frequency to the at least one core to cause the at least one core to operate at the working point frequency.

19. The system on chip of claim 18, wherein the power controller further comprises:
a first tracking error circuit coupled to the first PID controller, the first tracking error circuit to receive the determination of the first frequency and an indication of the working point frequency and determine therefrom the second feedback signal; and
a second tracking error circuit coupled to the second PID controller, the second tracking error circuit to receive the determination of the second frequency and the indication of the working point frequency and determine therefrom the fourth feedback signal.

20. The system on chip of claim 18, wherein the circuit is to receive at least one cap value and determine the working point frequency for the at least one core further based on the at least one cap value.
